(19) United States
(12) Patent Application Publication
(10) Pub. No.: US 2016/0053875 A1
(43) Pub. Date: Feb. 25, 2016

(54) VEHICLE POWER TRANSMISSION APPARATUS

(71) Applicant: HONDA MOTOR CO., LTD., Tokyo (JP)

(72) Inventor: Keisuke Kawamura, Wako-shi (JP)

(73) Assignee: HONDA MOTOR CO., LTD., Tokyo (JP)

(21) Appl. No.: 14/784,711

(22) PCT Filed: Mar. 31, 2014
(86) PCT No.: PCT/JP2014/059477

§ 371 Date: Oct. 15, 2015

(30) Foreign Application Priority Data
Apr. 16, 2013 (JP) 2013-085497

(51) Int. Cl. F16H 29/04; F16H 59/68

(52) U.S. Cl. CPC F16H 29/04; F16H 59/68

(57) ABSTRACT

In a crank-type vehicle power transmission apparatus, since an outer member of a one-way clutch has a large swing angular velocity when an amount of eccentricity of an input side fulcrum is large and a small swing angular velocity when the amount of eccentricity of the input side fulcrum is small, a projection fixed to the outer member is detected by a proximity sensor, the swing angular velocity of the outer member is calculated from a time gap of detection signals outputted by the proximity sensor, and the amount of eccentricity of the input side fulcrum can be estimated based on the swing angular velocity. Since the cumulative value of the detection signals is not used in the course of estimating the amount of eccentricity, the occurrence of error in estimation due to an accumulation of errors can be avoided.

### TECHNICAL FIELD

The present invention relates to a vehicle power transmission apparatus that includes an input shaft that is connected to a drive source, an output shaft that is disposed in parallel to the input shaft, an input side fulcrum that has a variable amount of eccentricity from an axis of the input shaft and rotates together with the input shaft, a one-way clutch that is connected to the output shaft, an output side fulcrum that is provided on an outer member of the one-way clutch, and a connecting rod that connects the input side fulcrum and the output side fulcrum.

### BACKGROUND ART

A crank type continuously variable transmission in which a plurality of power transmission units are arranged side by side in the axial direction, the power transmission units converting rotation of an input shaft connected to an engine into back-and-forth movement of a connecting rod and converting the back-and-forth movement of the connecting rod into rotation of an output shaft by means of a one-way clutch is known from Patent Document 1 below.

### RELATED ART DOCUMENTS

### Patent Documents

Patent Document 1: Japanese Patent Publication No. 2005-502543

### SUMMARY OF THE INVENTION

### Problems to be Solved by the Invention

In this kind of crank type continuously variable transmission, in order to control the operation of a shift actuator for changing the amount of eccentricity of an input side fulcrum that determines the stroke of back-and-forth movement of the connecting rod, it is necessary to estimate the amount of eccentricity of the input side fulcrum. When an attempt is made to estimate the amount of eccentricity from the gear ratio (input shaft rotational speed/output shaft rotational speed) based on the correlation between the amount of eccentricity of the input side fulcrum and the gear ratio, since as shown in FIG. 17 the crank type continuously variable transmission has the characteristic that the relationship between the amount of eccentricity and the gear ratio changes in response to transmission torque, it is not possible to estimate the amount of eccentricity from the gear ratio. Therefore, conventionally, attention has been focused on the correlation as shown in FIG. 18 between the amount of eccentricity and the cumulative value of the rotational angle of the shift actuator, which changes the amount of eccentricity, and the amount of eccentricity is estimated from the cumulative value of the rotational angle of the shift actuator. That is, the relationship of FIG. 18 in which the amount of eccentricity=0 when the cumulative rotational angle=0 is stored in advance as a map; when the shift actuator rotates in the normal rotational direction the rotational angle is added, and when the shift actuator rotates in the reverse rotational direction the rotational angle is subtracted, thus calculating the cumulative rotational angle and applying this cumulative rotational angle to the map to thus estimate the amount of eccentricity.

However, since it is inevitable that there is a slight error in the output of a rotational angle sensor for detecting the rotational angle of the shift actuator, errors in the output of the rotational angle sensor accumulate, thus causing the problem that the accuracy with which the amount of eccentricity is estimated deteriorates. For example, in FIG. 18, if the shift actuator is rotated forward 11000 deg in a state in which the cumulative rotational angle is 5000 deg and the amount of eccentricity is 7 mm so as to shift to a state in which the cumulative rotational angle is 16000 deg and the amount of eccentricity is 22.5 mm, since an error occurs in the cumulative rotational angle due to the accumulation of errors, the actual amount of eccentricity at the beginning when the cumulative rotational angle is 5000 deg is not 7 mm but is 7.5 mm, the amount of eccentricity when the cumulative rotational angle becomes 16000 deg becomes 23 mm not 22.5 mm, and this error makes it impossible to control the gear ratio with good accuracy.

The present invention has been accomplished in light of the above circumstances, and it is an object thereof to estimate with good accuracy the amount of eccentricity of an input side fulcrum of a crank type power transmission apparatus.

### Means for Solving the Problems

In order to attain the above object, according to a first aspect of the present invention, there is provided a vehicle power transmission apparatus comprising an input shaft that is connected to a drive source, an output shaft that is disposed in parallel to the input shaft, an input side fulcrum that has a variable amount of eccentricity from an axis of the input shaft and rotates together with the input shaft, a one-way clutch that is connected to the output shaft, an output side fulcrum that is provided on an outer member of the one-way clutch, and a connecting rod that connects the input side fulcrum and the output side fulcrum, wherein a projection that is fixed to the outer member is detected by a proximity sensor, and the amount of eccentricity is estimated based on a swing angular velocity of the outer member that is calculated from a time gap of a detection signal outputted by the proximity sensor.

Further, according to a second aspect of the present invention, in addition to the first aspect, the apparatus comprises one proximity sensor and two projections that are disposed so as to be spaced in a peripheral direction of the outer member, distances from the one proximity sensor to the two projections being different from each other.

Furthermore, according to a third aspect of the present invention, in addition to the first aspect, the apparatus comprises two proximity sensors that are disposed so as to be spaced in a peripheral direction of the outer member and one projection.

Moreover, according to a fourth aspect of the present invention, in addition to any one of the first to third aspects, the apparatus comprises a gear shaft that is disposed coaxially with the input shaft and changes the amount of eccentricity, a shift actuator that rotates the gear shaft relative to the input shaft, and an electric motor that drives the shift actuator, a first estimated value for the amount of eccentricity estimated based on a cumulative value of rotational angle of the electric motor being calibrated with a second estimated value for the amount of eccentricity estimated based on the swing angular velocity of the outer member.

Further, according to a fifth aspect of the present invention, in addition to the fourth aspect, when a deviation of the first estimated value with respect to the second estimated value is a predetermined value or greater, the first estimated value is calibrated with the second estimated value.

It should be noted here that an eccentric disk 19 of an embodiment corresponds to the input side fulcrum of the present invention, a link pin 37 of the embodiment corresponds to the output side fulcrum of the present invention, a first projection 42A and a second projection 42B of the embodiment correspond to the projection of the present invention, a first proximity sensor 43A and a second proximity sensor 43B of the embodiment correspond to the proximity sensor of the present invention, and an engine E of the embodiment corresponds to the drive source of the present invention.

### Effects of the Invention

In accordance with the first aspect of the present invention, since the vehicle power transmission apparatus includes the input side fulcrum, which has a variable amount of eccentricity from the axis of the input shaft and rotates together with the input shaft, the output side fulcrum, which is provided on the outer member of the one-way clutch provided on the output shaft, and the connecting rod, which connects the input side fulcrum and the output side fulcrum, when the input shaft rotates and the connecting rod moves back-and-forth, the one-way clutch is intermittently engaged to thus intermittently rotate the output shaft, thereby transmitting a driving force. In this process, varying the amount of eccentricity of the input side fulcnim from the axis of the input shaft changes the stroke of the back-and-forth movement of the connecting rod to thus vary the gear ratio.

Since the outer member of the one-way clutch has a large swing angular velocity when the amount of eccentricity of the input side fulcrum is large and a small swing angular velocity when the amount of eccentricity of the input side fulcrum is small, the projection fixed to the outer member is detected by the proximity sensor, the swing angular velocity of the outer member is calculated from the time gap of detection signals outputted by the proximity sensor, and the amount of eccentricity of the input side fulcrum can be estimated based on the swing angular velocity. Since the cumulative value of the detection signals is not used in the course of estimating the amount of eccentricity, it is possible to avoid the occurrence of error in estimation due to an accumulation of errors, thus improving the accuracy with which the amount of eccentricity is estimated.

Furthermore, in accordance with the second aspect of the present invention, since there are provided one proximity sensor and two projections disposed so as to be spaced in the peripheral direction of the outer member, and the distances from the proximity sensor to the two projections are different from each other, it is possible to reliably identify two swing positions of the outer member from the difference in magnitude of the detection signals for the two projections, and the swing angular velocity εan be calculated with high accuracy.

Moreover, in accordance with the third aspect of the present invention, since there are provided two proximity sensors disposed so as to be spaced in the peripheral direction of the outer member and one projection, it is possible to reliably identify two swing positions of the outer member from the outputs of the two proximity sensors, and the swing angular velocity can be calculated with high accuracy.

Furthermore, in accordance with the fourth aspect of the present invention, since there are provided the gear shaft, which is disposed coaxially with the input shaft and has a variable amount of eccentricity, the shift actuator, which rotates the gear shaft relative to the input shaft, and the electric motor, which drives the shift actuator, it is possible to estimate the amount of eccentricity of the input side fulcrum as a first estimated value based on the cumulative value of rotational angle of the electric motor. Although the accuracy of the first estimated value gradually decreases due to accumulation of errors in the detected value of the rotational angle of the electric motor, calibrating it with a second estimated value, which has high accuracy due to estimation based on the swing angular velocity of the outer member, enables the accuracy of the first estimated value to be maintained.

Moreover, in accordance with the fifth aspect of the present invention, since the first estimated value is calibrated with the second estimated value when the deviation of the first estimated value with respect to the second estimated value is a predetermined value or greater, it is possible to maintain the accuracy of the first estimated value while minimizing the number of times calibration is carried out.

### BRIEF DESCRIPTION OF DRAWINGS

FIG. 1 is an overall view of a vehicle power transmission apparatus. (first embodiment)

FIG. 2 is a partially cutaway perspective view of an essential part of the vehicle power transmission apparatus. (first embodiment)

FIG. 3 is a sectional view along line 3-3 in FIG. 1. (first embodiment)

FIG. 4 is an enlarged view of part 4 in FIG. 3. (first embodiment)

FIG. 5 is a skeleton diagram of a shift actuator. (first embodiment)

FIG. 6 is a sectional view along line 6-6 in FIG. 3. (first embodiment)

FIG. 7 is a view showing the shape of an eccentric disk. (first embodiment)

FIG. 8 is a diagram showing the relationship between amount of eccentricity and output of a proximity sensor. (first embodiment)

FIG. 9 is a diagram showing the state of the eccentric disk at an OD gear ratio and at a GN gear ratio. (first embodiment)

FIG. 10 is an alignment chart of first to third planetary gear mechanisms (state in which the gear ratio is constant). (first embodiment)

FIG. 11 is an alignment chart of the first to third planetary gear mechanisms (state in which the gear ratio is variable). (first embodiment)

FIG. 12 is a flowchart showing a procedure for estimating and calibrating the amount of eccentricity. (first embodiment)

FIG. 13 is a map from which the amount of eccentricity is determined from engine rotational speed and angular velocity of an outer member. (first embodiment)

FIG. 14 is a diagram showing the position of a projection of the outer member and first and second proximity sensors. (second embodiment)

FIG. 15 is a diagram showing the position of a projection of the outer member and a proximity sensor. (third embodiment)

FIG. 16 is a diagram showing the relationship between amount of eccentricity and output of a proximity sensor. (fourth embodiment)

FIG. 17 is a graph showing the relationship between gear ratio, transmission torque, and amount of eccentricity of a continuously variable transmission. (conventional example)

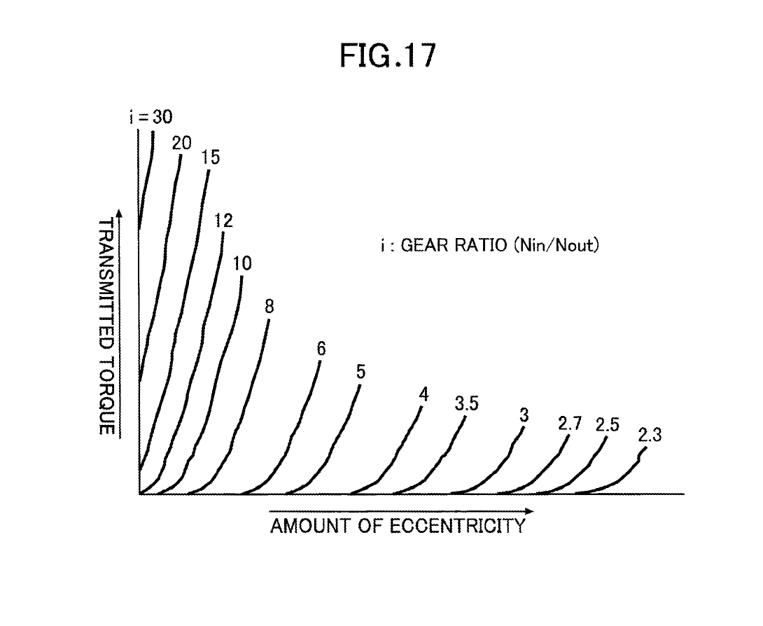

FIG. 18 is a graph showing the relationship between cumulative rotational angle and amount of eccentricity of a shift actuator. (conventional example)

### EXPLANATION OF REFERENCE NUMERALS AND SYMBOLS

12 Input shaft

13 Output shaft

15 Gear shaft

19 Eccentric disk (input side fulcrum)

23 Shift actuator

24 Electric motor

33 Connecting rod

36 One-way clutch

37 Link pin (output side fulcrum)

38 Outer member

42 Projection

42A First projection (projection)

42B Second projection (projection)

43 Proximity sensor

43A First proximity sensor (proximity sensor)

43B Second proximity sensor (proximity sensor)

E Engine (drive source)

L Axis of input shaft

Tgap Time gap of detection signal

α′ Swing angular velocity of outer member

ε Amount of eccentricity

### MODES FOR CARRYING OUT THE INVENTION

Embodiments of the present invention are explained below by reference to the attached drawings.

### First Embodiment

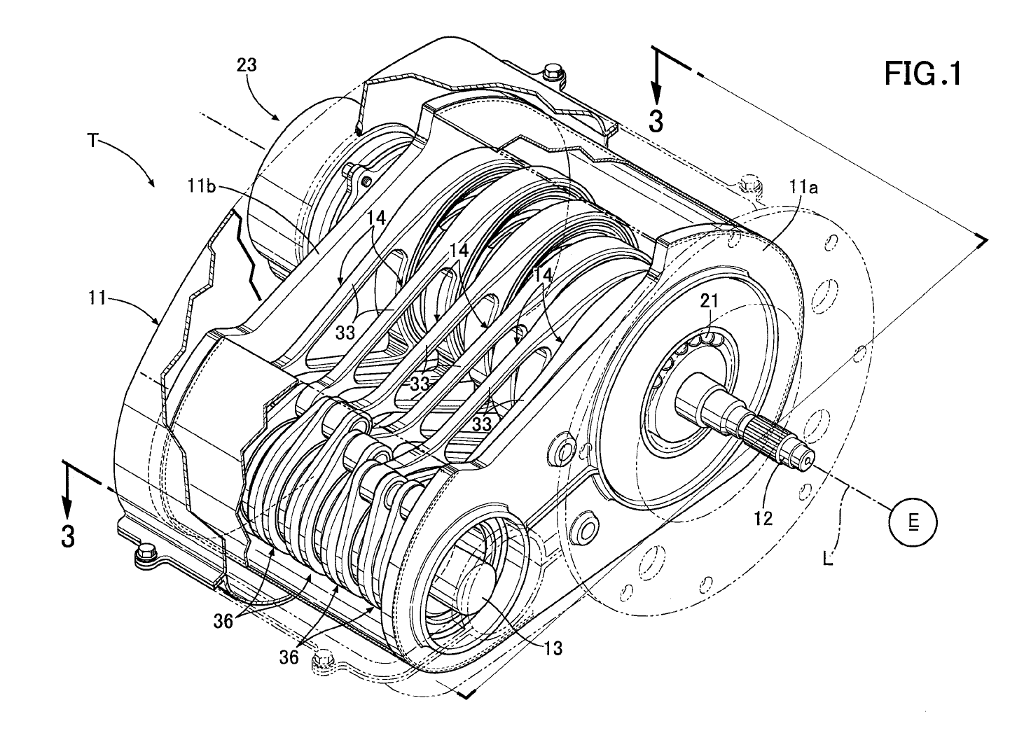

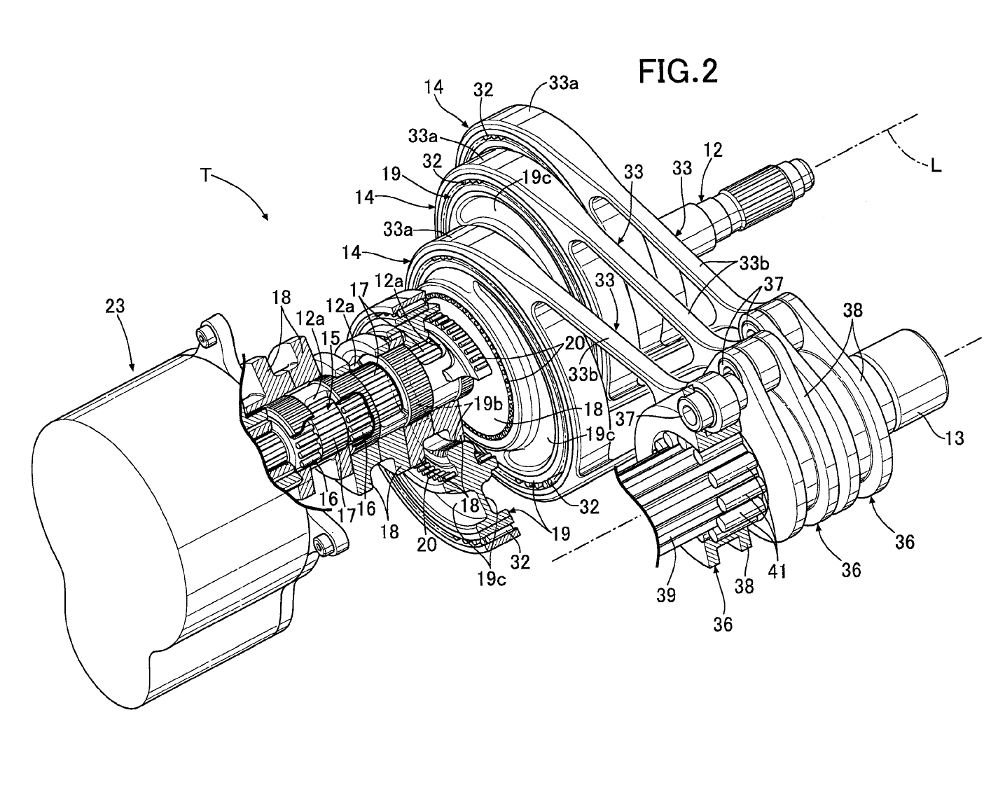

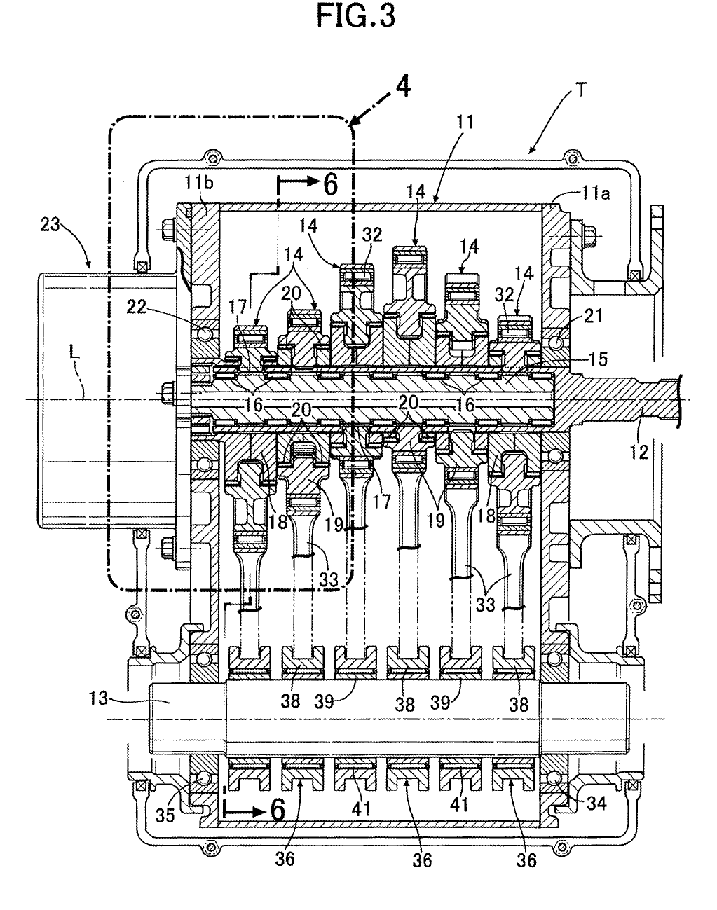

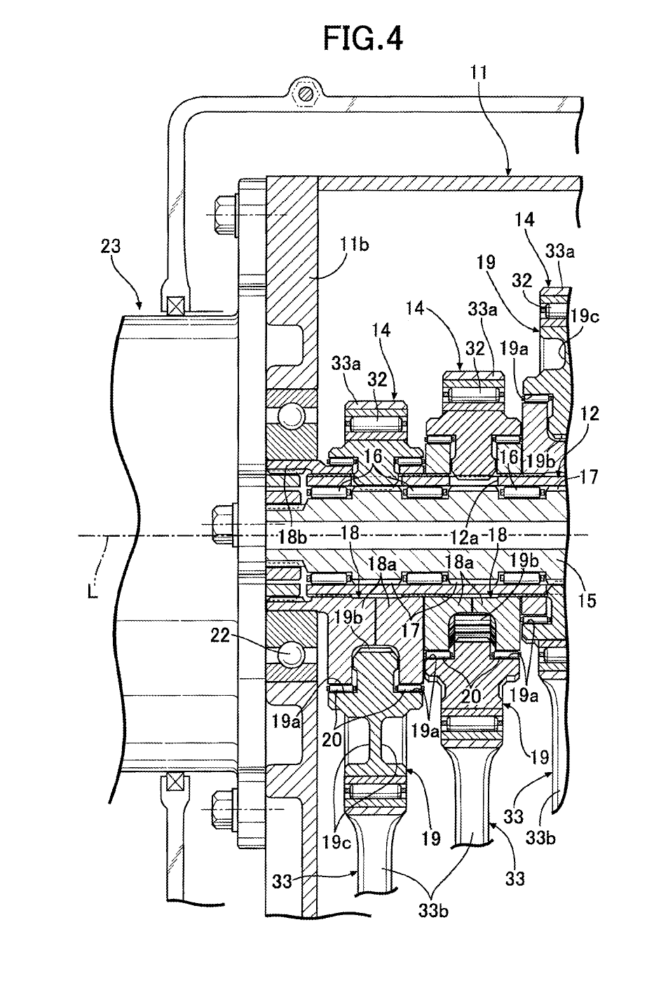

A first embodiment of the present invention is now explained by reference to FIG. 1 to FIG. 13.

As shown in FIG. 1 to FIG. 4, an input shaft 12 and an output shaft 13 are supported on a pair of side walls 11a and 11b of a transmission case 11 of a continuously variable transmission T for an automobile so as to be parallel to each other, and rotation of the input shaft 12 connected to an engine E is transmitted to a driven wheel via six transmission units 14, the output shaft 13, and a differential gear. A transmission shaft 15 having a common axis L with the input shaft 12 is relatively rotatably fitted into the interior of the input shaft 12, which is hollow, via seven needle bearings 16. Since the structures of the six transmission units 14 are substantially identical, the structure of one transmission unit 14 is explained below as being representative thereof.

The transmission unit 14 includes a pinion 17 provided on an outer peripheral face of the transmission shaft 15, and this pinion 17 is exposed through an opening 12a formed in the input shaft 12. A disk-shaped eccentric cam 18, which is split into two in the axis L direction, is spline joined to the outer periphery of the input shaft 12 so as to sandwich the pinion 17. A center O1 of the eccentric cam 18 is eccentric to the axis L of the input shaft 12 only by a distance d. The phases in the direction of eccentricity of the six eccentric cams 18 of the six transmission units 14 are displaced from each other by 60°.

A pair of eccentric recess portions 19a and 19a formed in opposite end faces in the axis L direction of a disk-shaped eccentric disk 19 are rotatably supported on an outer peripheral face of the eccentric cam 18 via a pair of needle bearings 20 and 20. The center O1 of the eccentric recess portions 19a and 19a (that is, the center O1 of the eccentric cam 18) is displaced only by the distance d with respect to a center O2 of the eccentric disk 19. That is, the distance d between the axis L of the input shaft 12 and the center O1 of the eccentric cam 18 is identical to the distance d between the center O1 of the eccentric cam 18 and the center O2 of the eccentric disk 19.

A pair of crescent-shaped guide portions 18a and 18a, which are coaxial with the center O1 of the eccentric cam 18, are provided on split faces of the eccentric cam 18, which is split into two in the axis L direction, and the extremities of teeth of a ring gear 19b formed so as to provide communication between bottom parts of the pair of eccentric recess portions 19a and 19a of the eccentric disk 19 abut slidably against outer peripheral faces of the guide portions 18a and 18a of the eccentric cam 18. The pinion 17 of the transmission shaft 15 meshes with the ring gear 19b of the eccentric disk 19 through the opening 12a of the input shaft 12.

One end side of the input shaft 12 is directly supported on one side wall 11a of the transmission case 11 via a ball bearing 21. Furthermore, a tubular portion 18b provided integrally with one eccentric cam 18 positioned on the other end side of the input shaft 12 is supported on the other side wall 11b of the transmission case 11 via a ball bearing 22, and the other end side of the input shaft 12 spline-joined to the inner periphery of the eccentric cam 18 is indirectly supported on the transmission case 11.

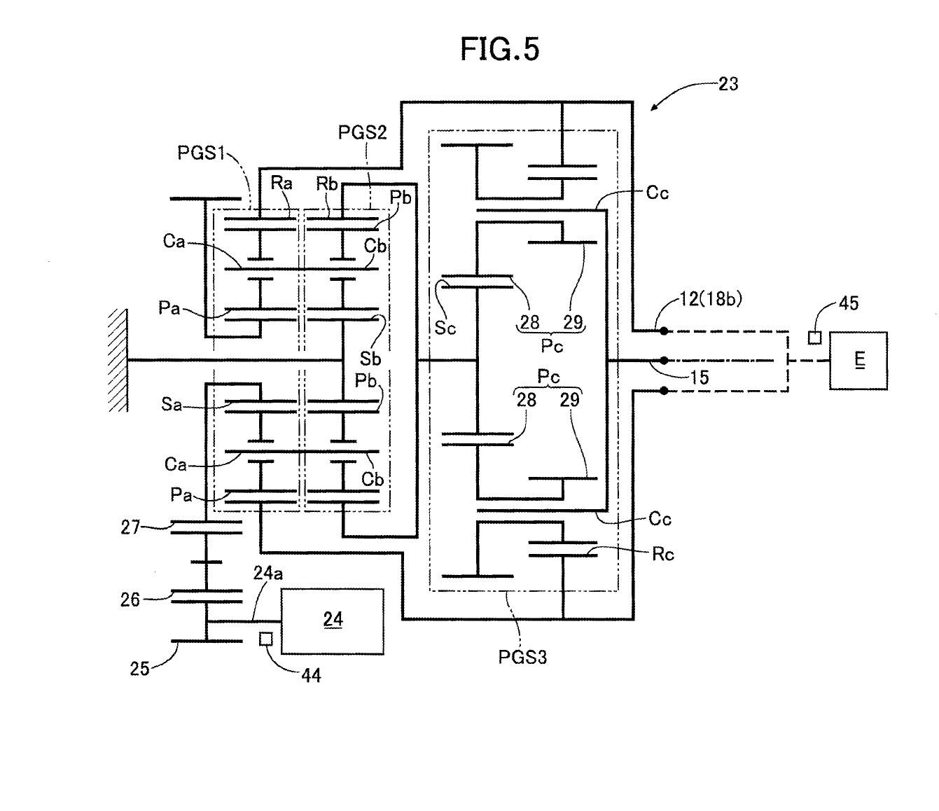

As shown in FIG. 5, a shift actuator 23 for changing the gear ratio of the continuously variable transmission T by rotating the gear shaft 15 relative to the input shaft 12 includes a first planetary gear mechanism PGS1, a second planetary gear mechanism PGS2, and a third planetary gear mechanism PGS3, which are disposed on the axis L of the input shaft 12.

The first planetary gear mechanism PGS1, which is of a single pinion type, includes a first sun gear Sa, a first ring gear Ra, a first carrier Ca, and a plurality of first pinions Pa that are rotatably supported on the first carrier Ca and mesh simultaneously with the first sun gear Sa and the first ring gear Ra. The second planetary gear mechanism PGS2, which is of a single pinion type, includes a second sun gear Sb, a second ring gear Rb, a second carrier Cb, and a plurality of second pinions Pb that are rotatably supported on the second carrier Cb and mesh simultaneously with the second sun gear Sb and the second ring gear Rb. The first carrier Ca of the first planetary gear mechanism PGS1 and the second carrier Cb of the second planetary gear mechanism PGS2 rotate as a unit. In the present embodiment, the number of teeth of the first sun gear Sa and the number of teeth of the second sun gear Sb are identical, the number of teeth of the first ring gear Ra and the number of teeth of the second ring gear Rb are identical, and the number of teeth of the first pinion Pa and the number of teeth of the second pinion Pb are identical.

A pinion 25 provided on a motor shaft 24a of an electric motor 24 of the shift actuator 23 is connected to the first sun gear Sa of the first planetary gear mechanism PGS1 via a first reduction gear 26 and a second reduction gear 27, and driving the electric motor 24 makes the first sun gear Sa rotate. The second sun gear Sb of the second planetary gear mechanism PGS2 is fixed to a casing.

The third planetary gear mechanism PGS3, which is of a single pinion type, includes a third sun gear Sc, a third ring gear Rc, a third carrier Cc, and a plurality of third pinions Pc that are rotatably supported on the third carrier Cc. The third pinion Pc is formed from a double pinion in which a large diameter pinion 28 and a small diameter pinion 29 are formed as a unit, the large diameter pinion 28 meshing with the third sun gear Sc, and the small diameter pinion 29 meshing with the third ring gear Rc.

The first ring gear Ra of the first planetary gear mechanism PGS1 is connected to the third ring gear Rc of the third planetary gear mechanism PGS3 and the input shaft 12 (specifically the tubular portion 18b of the eccentric cam 18), and the second ring gear Rb of the second planetary gear mechanism PGS2 is connected to the third sun gear Sc of the third planetary gear mechanism PGS3. The third carrier Cc of the third planetary gear mechanism PGS3 is connected to the gear shaft 15.

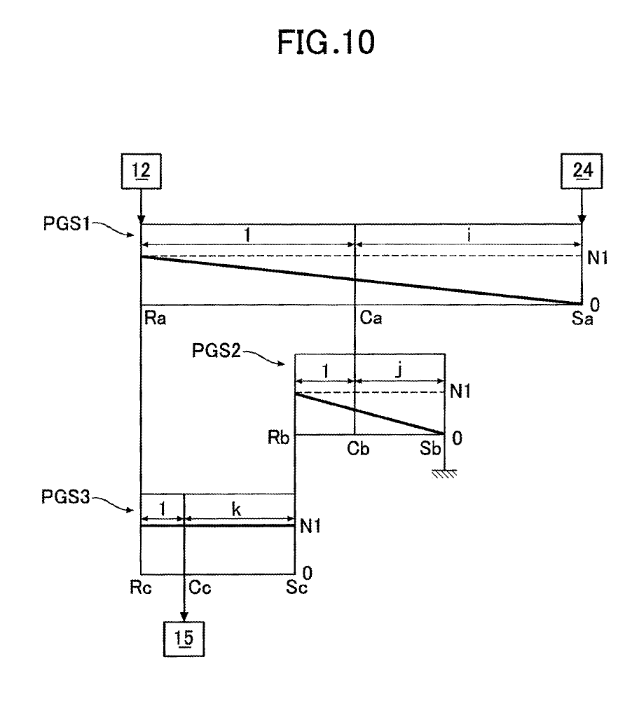

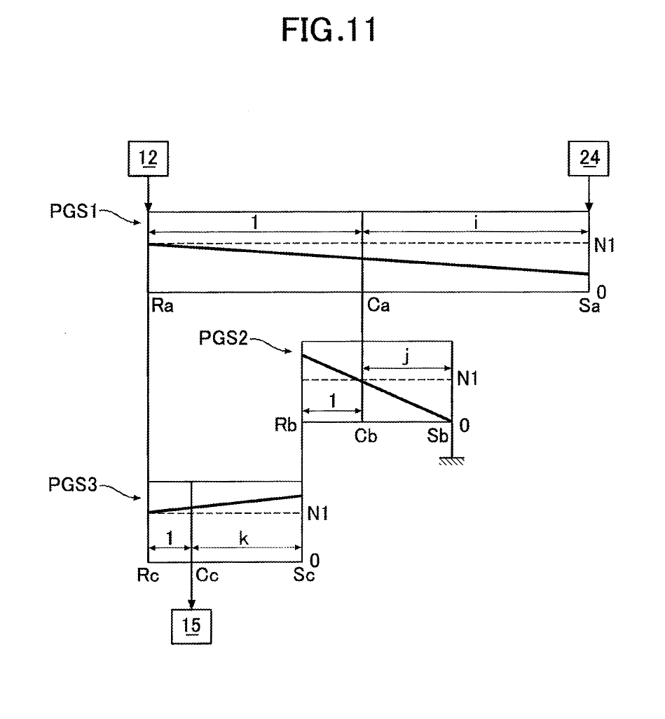

FIG. 10 and FIG. 11 show alignment charts of the first to third planetary gear mechanisms PGS1, PGS1 and PGS3, the upper section corresponding to the first planetary gear mechanism PGS1, the middle section corresponding to the second planetary gear mechanism PGS2, and the lower section corresponding to the third planetary gear mechanism PGS3.

The gear ratio (number of teeth of first ring gear Ra/number of teeth of first sun gear Sa) of the first planetary gear mechanism PGS1 is i, and in the alignment chart the ratio of the gap between the first sun gear Sa and the first carrier Ca and the gap between the first carrier Ca and the first ring gear Ra is i:1. The rotational speed of the first ring gear Ra connected to the input shaft 12 (engine E) is N1, which is the engine rotational speed. Therefore, as the rotational speed of the first sun gear Sa connected to the electric motor 24 changes, the rotational speed of the first carrier Ca changes accordingly.

The gear ratio of the second planetary gear mechanism PGS2 (number of teeth of second ring gear Rb/number of teeth of second sun gear Sb) is j, and in the alignment chart the ratio of the gap between the second sun gear Sb and the second carrier Cb and the gap between the second carrier Cb and the second ring gear Rb is j:1. The rotational speed of the second sun gear Sb fixed to the casing is zero. Therefore, as the rotational speed of the second carrier Cb connected to the first carrier Ca of the first planetary gear mechanism PGS1 changes, the rotational speed of the second ring gear Rb changes accordingly. In the present embodiment, the gear ratio i of the first planetary gear mechanism PGS1 coincides with the gear ratio j of the second planetary gear mechanism PGS2.

The gear ratio of the third planetary gear mechanism PGS3 [(number of teeth of third ring gear Rc/number of teeth of third sun gear Sc)×(number of teeth of large diameter pinion 28/number of teeth of small diameter pinion 29)] is k, and in the alignment chart the ratio of the gap between the third sun gear Sc and the third carrier Cc and the gap between the third carrier Cc and the third ring gear Rc is k:1. The rotational speed of the third ring gear Rc connected to the input shaft 12 (engine E) is N1, which is the engine rotational speed; therefore, as the rotational speed of the third sun gear Sc connected to the second ring gear Rb of the second planetary gear mechanism PGS2 changes, the rotational speed of the third carrier Cc, that is, the rotational speed of the gear shaft 15, changes accordingly.

As shown in FIG. 10, when the electric motor 24 of the shift actuator 23 stops, the rotational speed of the third carrier Cc of the third planetary gear mechanism PGS3 (the rotational speed of the gear shaft 15) coincides with the rotational speed of the input shaft 12 (the engine rotational speed N1). That is, when the electric motor 24 stops, the rotational speed of the first sun gear Sa of the first planetary gear mechanism PGS1 becomes zero, and since the rotational speed of the second sun gear Sb of the second planetary gear mechanism PGS2 fixed to the casing is zero, the rotational speed of the first ring gear Ra and the rotational speed of the second ring gear Rb of the first planetary gear mechanism PGS1 and the second planetary gear mechanism PGS2, for which the gear ratios i and j are identical, coincide with each other. Since the first ring gear Ra is connected to the input shaft 12, the rotational speed of the second ring gear Rb coincides with the rotational speed of the input shaft 12, both being equal to the engine rotational speed N1.

As a result, the rotational speed of the third ring gear Rc of the third planetary gear mechanism PGS3 connected to the input shaft 12 and the rotational speed of the third sun gear Sc of the third planetary gear mechanism PGS3 connected to of the second ring gear Rb of the second planetary gear mechanism PGS2 both coincide with the rotational speed of the input shaft 12, the third planetary gear mechanism PGS3 attains a locked state, and the respective elements rotate as a unit at the rotational speed of the input shaft 12. This allows the input shaft 12 connected to the third ring gear Rc of the third planetary gear mechanism PGS3 and the gear shaft 15 connected to the third carrier Cc of the third planetary gear mechanism PGS3 to rotate at the same speed, which is equal to the engine rotational speed N1. That is, when the electric motor 24 of the shift actuator 23 is stopped, the rotational speed of the input shaft 12 and the rotational speed of gear shaft 15 coincide with each other.

As shown in FIG. 11, when the electric motor 24 of the shift actuator 23 is driven in the same direction as that for the input shaft 12, the rotational speed of the first carrier Ca of the first planetary gear mechanism PGS1 increases, the rotational speed of the second carrier Cb of the second planetary gear mechanism PGS2 increases, and the rotational speed of the second ring gear Rb thereby increases. As a result, the rotational speed of the third sun gear Sc of the third planetary gear mechanism PGS3 increases from the rotational speed N1 of the input shaft 12, and in response thereto the rotational speed of the third carrier Cc increases from the rotational speed N1 of the input shaft 12. That is, driving the electric motor 24 of the shift actuator 23 in the same direction as that for the input shaft 12 enables the rotational speed of the gear shaft 15 to be increased with respect to the rotational speed of the input shaft 12. On the other hand, driving the electric motor 24 of the shift actuator 23 in the direction opposite to that for the input shaft 12 enables the rotational speed of the gear shaft 15 to be decreased with respect to the rotational speed of the input shaft 12.

Returning to FIG. 1 to FIG. 4, an annular portion 33a on one end side of a connecting rod 33 is relatively rotatably supported on the outer periphery of the eccentric disk 19 via a roller bearing 32. The output shaft 13 is supported on the pair of side walls 11a and 11b of the transmission case 11 by means of a pair of ball bearings 34 and 35, and a one-way clutch 36 is supported on the outer periphery of the output shaft 13. The one-way clutch 36 includes a ring-shaped outer member 38 pivotably supported on the extremity of the rod portion 33b of the connecting rod 33 via a link pin 37, an inner member 39 disposed in the interior of the outer member 38 and fixed to the output shaft 13, and a plurality of rollers 41 disposed in a wedge-shaped space formed between an arc face on the inner periphery of the outer member 38 and a flat face on the outer periphery of the inner member 39 and urged by a plurality of springs 40.

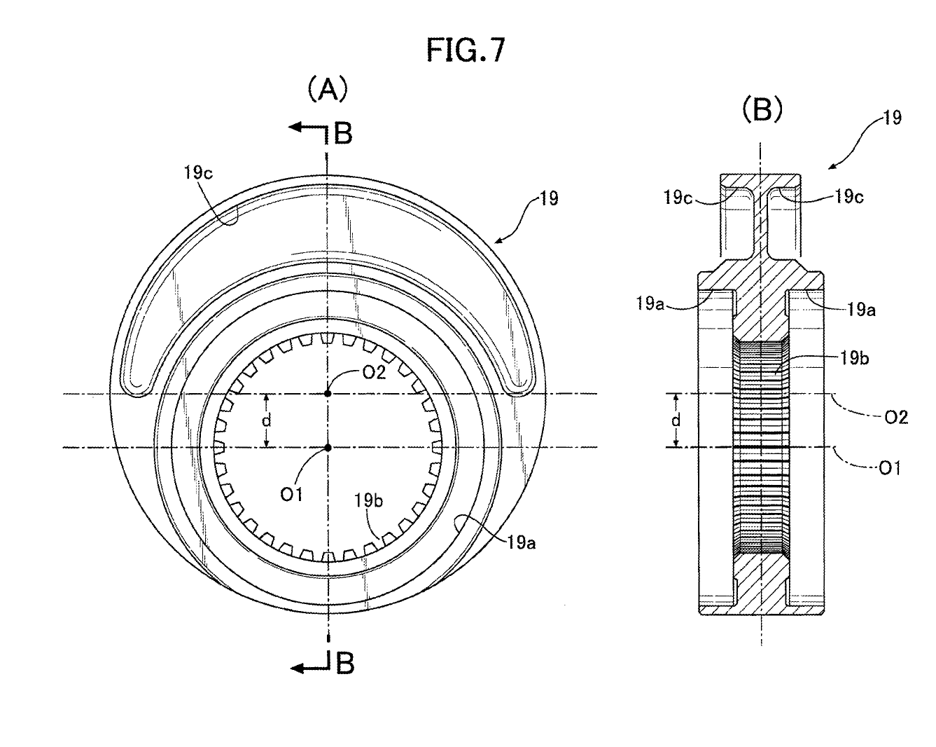

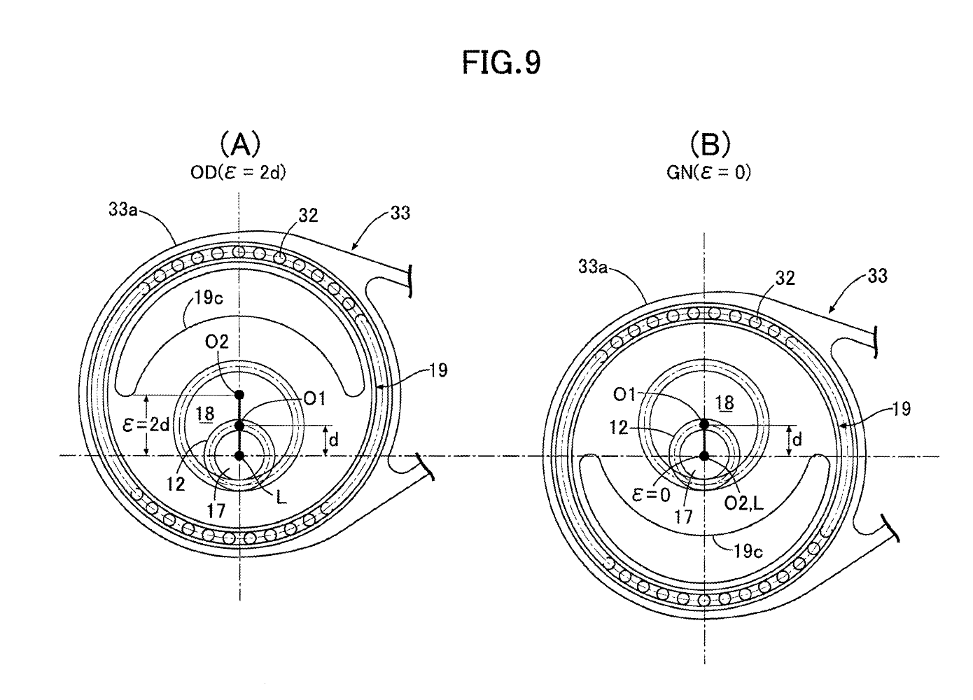

As shown in FIG. 7 and FIG. 9, the center O1 of the eccentric recess portions 19a and 19a (that is, the center O1 of the eccentric cam 18) is displaced by the distance d with respect to the center O2 of the eccentric disk 19, the gap between the outer periphery of the eccentric disk 19 and the inner periphery of the eccentric recess portions 19a and 19a is non-uniform in the circumferential direction, and crescent-shaped cutout recess portions 19c and 19c are formed in a section where the gap is large.

The operation of one transmission unit 14 of the continuously variable transmission T is now explained.

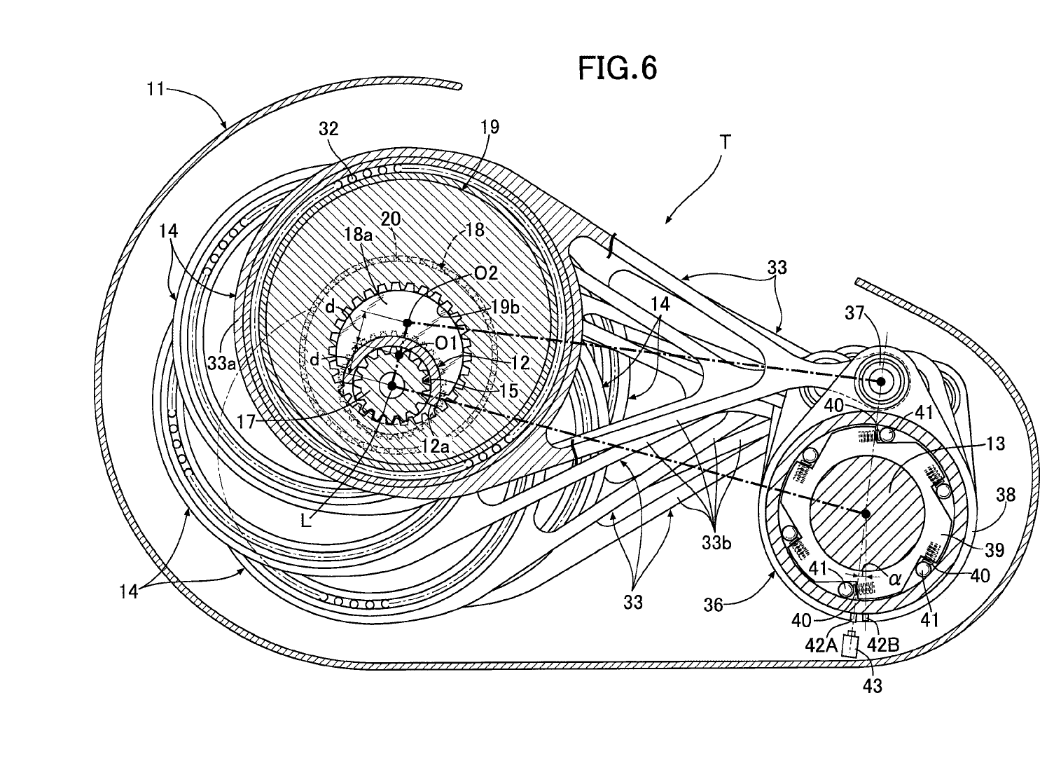

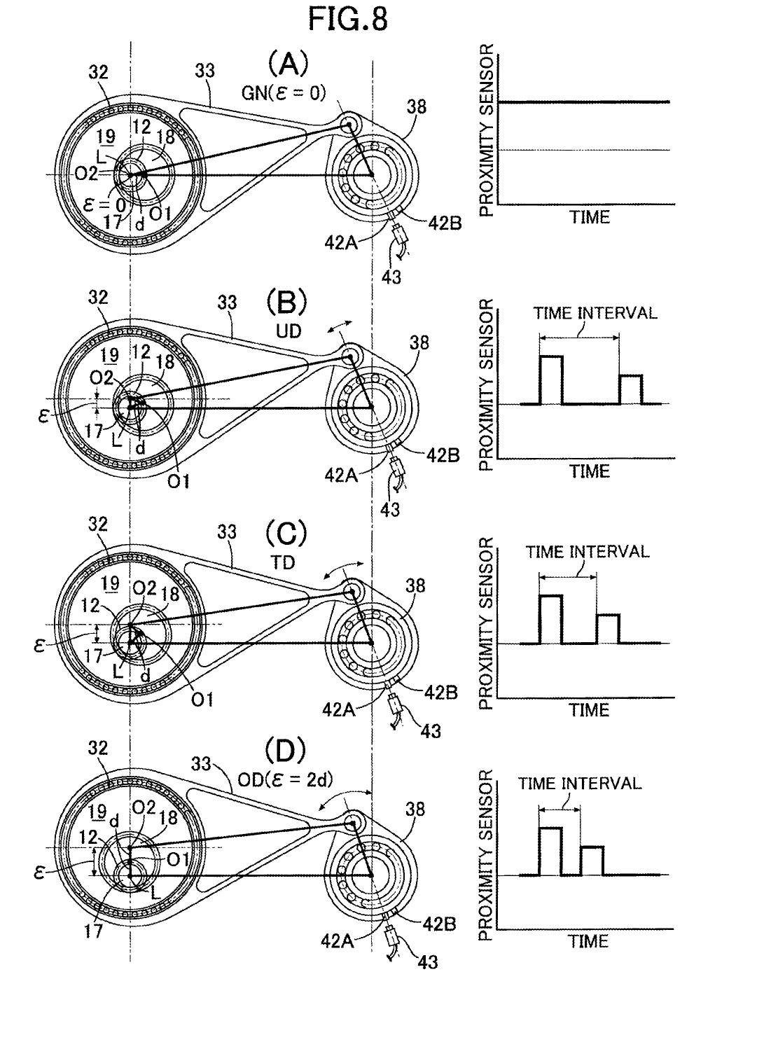

As is clear from FIG. 6 and FIG. 8(A) to FIG. 8(D), if the center O2 of the eccentric disk 19 is eccentric with respect to the axis L of the input shaft 12, when the input shaft 12 is rotated by the engine E, the annular portion 33a of the connecting rod 33 rotates eccentrically around the axis L, and the rod portion 33b of the connecting rod 33 moves back-and-forth.

As a result, in FIG. 6, when the connecting rod 33 is pushed rightward in the figure in the process of moving back-and-forth, the rollers 41 urged by the springs 40 bite into the wedge-shaped spaces between the outer member 38 and the inner member 39; due to the outer member 38 and the inner member 39 being joined via the rollers 41, the one-way clutch 36 is engaged, and movement of the connecting rod 33 is transmitted to the output shaft 13. On the other hand, when the connecting rod 33 is pulled leftward in the figure during the process of moving back-and-forth, the rollers 41 are pushed out from the wedge-shaped spaces between the outer member 38 and the inner member 39 while compressing the springs 40; due to the outer member 38 and the inner member 39 slipping relative to each other, engagement of the one-way clutch 36 is released, and movement of the connecting rod 33 is not transmitted to the output shaft 13.

In this way, since, while the input shaft 12 rotates once, rotation of the input shaft 12 is transmitted to the output shaft 13 only for a predetermined time, if the input shaft 12 rotates continuously, the output shaft 13 rotates intermittently. Since the phases in the direction of eccentricity of the eccentric disks 19 of the six transmission units 14 are displaced from each other by 60°, the six transmission units 14 transmit rotation of the input shaft 12 to the output shaft 13 in turn, and the output shaft 13 rotates continuously.

In this process, the larger the amount of eccentricity ε of the eccentric disk 19, the larger the back-and-forth stroke of the connecting rod 33 becomes, the rotational angle of the output shaft 13 per cycle increases, and the gear ratio of the continuously variable transmission T becomes small. On the other hand, the smaller the amount of eccentricity ε of the eccentric disk 19, the smaller the back-and-forth stroke of the connecting rod 33 becomes, the rotational angle of the output shaft 13 per cycle decreases, and the gear ratio of the continuously variable transmission T becomes large. When the amount of eccentricity ε of the eccentric disk 19 becomes zero, even if the input shaft 12 rotates, the connecting rod 33 stops moving, the output shaft 13 therefore does not rotate, and the gear ratio of the continuously variable transmission T becomes the maximum (infinite).

When the gear shaft 15 does not rotate relative to the input shaft 12, that is, when the electric motor 24 of the shift actuator 23 stops and the input shaft 12 and the gear shaft 15 rotate at the same speed, the gear ratio of the continuously variable transmission T is held constant. On the other hand, when the electric motor 24 of the shift actuator 23 is driven, the gear shaft 15 rotates relative to the input shaft 12, the eccentric recess portions 19a and 19a of the eccentric disk 19 having the ring gear 19b meshing with the pinion 17 of each transmission unit 14 rotate while being guided by the guide portions 18a and 18a of the eccentric cam 18, which is integral with the input shaft 12, and the amount of eccentricity ε of the center O2 of the eccentric disk 19 with respect to the axis L of the input shaft 12 changes.

FIG. 8(D) and FIG. 9(A) show a state in which the gear ratio is a minimum (gear ratio: OD); here, the amount of eccentricity ε of the center O2 of the eccentric disk 19 with respect to the axis L of the input shaft 12 becomes a maximum value of 2d, which is equal to the sum of the distance d from the axis L of the input shaft 12 to the center O1 of the eccentric cam 18 and the distance d from the center O1 of the eccentric cam 18 to the center O2 of the eccentric disk 19. When the transmission shaft 15 rotates relative to the input shaft 12, the eccentric disk 19 rotates relative to the eccentric cam 18, which is integral with the input shaft 12, as shown in FIG. 8(C) and FIG. 8(B) the amount of eccentricity ε of the center O2 of the eccentric disk 19 with respect to the axis L of the input shaft 12 gradually decreases from a maximum value of 2d, and the gear ratio increases. When the transmission shaft 15 rotates further relative to the input shaft 12, the eccentric disk 19 rotates further relative to the eccentric cam 18, which is integral with the input shaft 12, as shown in FIG. 8(A) and FIG. 9(B) the center O2 of the eccentric disk 19 finally overlaps the axis L of the input shaft 12, the amount of eccentricity ε becomes zero, the gear ratio attains a maximum (infinite) state (gear ratio: GN), and power transmission to the output shaft 13 is cut off

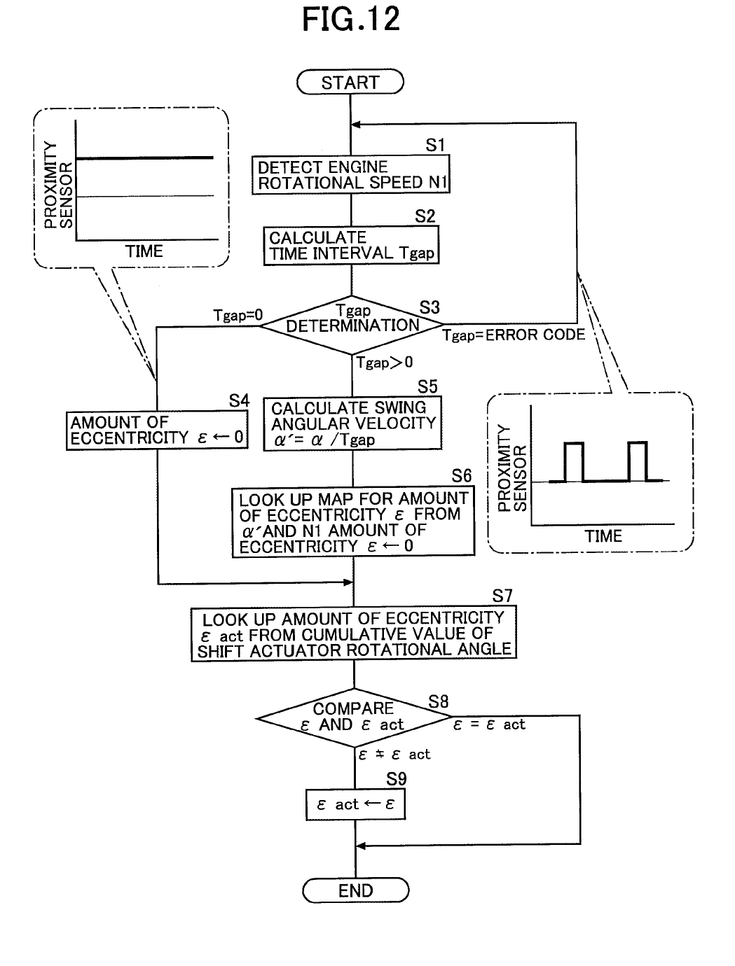

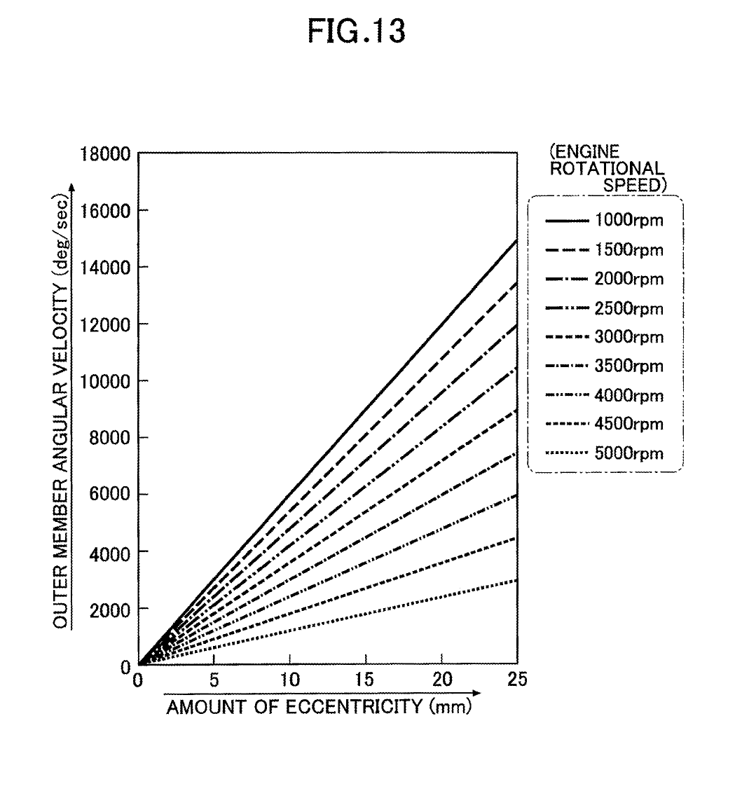

Estimation of the amount of eccentricity ε of the eccentric disk 19 is now explained by reference to FIG. 6, FIG. 8, FIG. 12, and FIG. 13.

As shown in FIG. 6 and FIG. 8, a first projection 42A and a second projection 42B, spaced in the circumferential direction, are projectingly provided on an outer peripheral face of the outer member 38 of any one of the one-way clutches 36, and a proximity sensor 43 of an inductive type, a capacitive type, a magnetic type, etc. is provided so as to oppose the first projection 42A and the second projection 42B. The projection height in the radial direction of the first projection 42A is set so as to be larger than the projection height of the second projection 42B in the radial direction. The proximity sensor 43 outputs a pulse-shaped signal when the first projection 42A or the second projection 42B passes through its vicinity, and the magnitude of the output signal is larger for the first projection 42A, which is taller, than for the second projection 42B, which is shorter.

As shown in FIG. 8(A), when the gear ratio is GN, the outer member 38 of the one-way clutch 36 stops swinging, and the output of the proximity sensor 43 thus becomes zero. As shown in FIGS. 8(B), (C), and (D), when the gear ratio is UD, TD, and OD, the first projection 42A and the second projection 42B pass through the vicinity of the proximity sensor 43 while the outer member 38 swings in the counterclockwise direction, and the proximity sensor 43 therefore outputs two signals. The first large signal is a first signal attributable to the tall first projection 42A, and the next small signal is a second signal attributable to the short second projection 42B.

If it is assumed that the rotational speed of the input shaft 12 is constant, accompanying a decrease of the gear ratio in order UD→TD→OD, the stroke of the connecting rod 33 increases, the angular velocity of swinging of the outer member 38 of the one-way clutch 36 increases, and the time gap between the first signal and the second signal therefore gradually becomes small. Therefore, it is possible by measuring the time gap between the first signal and the second signal to estimate the amount of eccentricity ε of the eccentric disk 19 from the time gap.

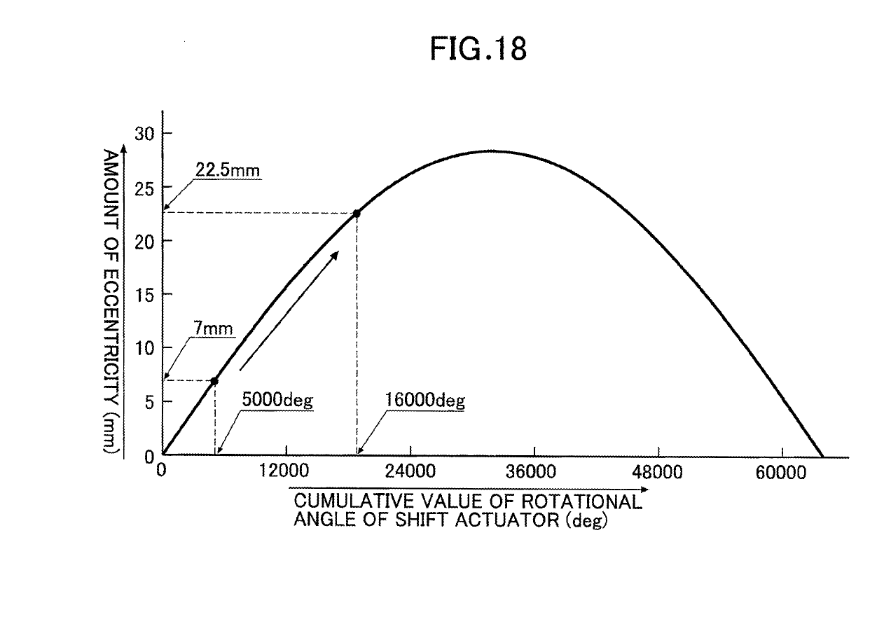

On the other hand, the electric motor 24 of the shift actuator 23 is provided with a rotational angle sensor 44 for detecting the rotational angle of the motor shaft 24a (see FIG. 5). The rotational angle sensor 44 calculates the cumulative value for the rotational angle by adding the rotational angle in one direction of the electric motor 24 and subtracting the rotational angle in the other direction. As explained for FIG. 18, the cumulative value for the rotational angle detected by the rotational angle sensor 44 corresponds to the amount of eccentricity ε of the eccentric disk 19. The engine E is provided with an engine rotational speed sensor 45 for detecting engine rotational speed (see FIG. 5).

The procedure by which the amount of eccentricity ε of the eccentric disk 19 is estimated is now explained by reference to the flowchart of FIG. 12.

First, in step S1 the engine rotational speed N1 is detected by the engine rotational speed sensor 44. In the subsequent step S2 a time gap Tgap between the first signal for the first projection 42A and the second signal for the second projection 42B outputted by the proximity sensor 43 is calculated. In the subsequent step S3, if the time gap Tgap is zero, that is, if the first and second signals are not detected (see FIG. 8(A)), then in step S4 it is estimated that the amount of eccentricity ε of the eccentric disk 19 is zero. If in step S3 only the first signal corresponding to the tall first projection 42A is continuously detected due to the amount of eccentricity ε being small (due to the swing angle of the outer member 38 being small) or if only the second signal corresponding to the short second projection 42B is continuously detected, since it is impossible to estimate the amount of eccentricity ε, the procedure returns to step S1.

When in step S3 the time gap Tgap is calculated, then in step S5 a swing angular velocity α′ of the outer member 38 of the one-way clutch 36 is calculated using α′=α/Tgap. Here, α is the difference in phase between the first projection 42A and the second projection 42B (see FIG. 6). In the subsequent step S6 the swing angular velocity α′ and the engine rotational speed N1 detected by the engine rotational speed sensor 44 are applied to the map shown in FIG. 13, and the amount of eccentricity ε of the eccentric disk 19 is thereby estimated.

In the subsequent step S7 the cumulative value for the rotational angle of the electric motor 24 of the shift actuator 23 detected by the rotational angle sensor 44 is applied to the map of FIG. 18 to thus look up the amount of eccentricity act of the eccentric disk 19. In the subsequent step S8 the amount of eccentricity ε of the eccentric disk 19 determined from the time gap Tgap is compared with the amount of eccentricity εact of the eccentric disk 19 determined from the cumulative value for the rotational speed of the electric motor 24, and if the two do not coincide with each other and the deviation is a predetermined value or greater, then the amount of eccentricity tact is replaced by the amount of eccentricity ε, thus executing calibration.

As hereinbefore described, in accordance with the present embodiment, focusing attention on the swing angular velocity α′ of the outer member 38 of the one-way clutch 36 becoming large when the amount of eccentricity ε of the eccentric disk 19 is large and becoming small when the amount of eccentricity ε of the eccentric disk 19 is small, the first projection 42A and the second projection 42B fixed to the outer member 38 are detected by means of the proximity sensor 43, the swing angular velocity α′ of the outer member 38 is calculated from the time gap Tgap between detection signals outputted by the proximity sensor 43, and the amount of eccentricity ε of the eccentric disk 19 can be estimated based on the swing angular velocity α′. Since the cumulative value for the detection signals is not used in the course of estimating the amount of eccentricity ε, it is possible to avoid the occurrence of estimation error due to the accumulation of errors, thus improving the accuracy with which the amount of eccentricity ε is estimated.

Moreover, since there are provided one proximity sensor 43 and the first projection 42A and the second projection 42B disposed so as to be spaced in the peripheral direction of the outer member 38, and the distances from the proximity sensor 43 to the first and second projections 42A and 42B are made different, it is possible to calculate the swing angular velocity α′ with high accuracy from the difference in magnitude of the detection signals for the first and second projections 42A and 42B by reliably differentiating the two swing positions of the outer member 38.

That is, when the time gap Tgap can not be detected in reality due to the swing angle of the outer member 38 being small, even if, in the course of the outer member 38 swinging in one direction, the proximity sensor 43 detects for example the first projection 42A alone and, in the course of swinging in the other direction, the proximity sensor 43 again detects the first projection 42A alone, because the two detection signals are identical in magnitude, it is possible to avoid a situation in which the time gap Tgap, which can not be detected in reality, is erroneously detected.

### Second Embodiment

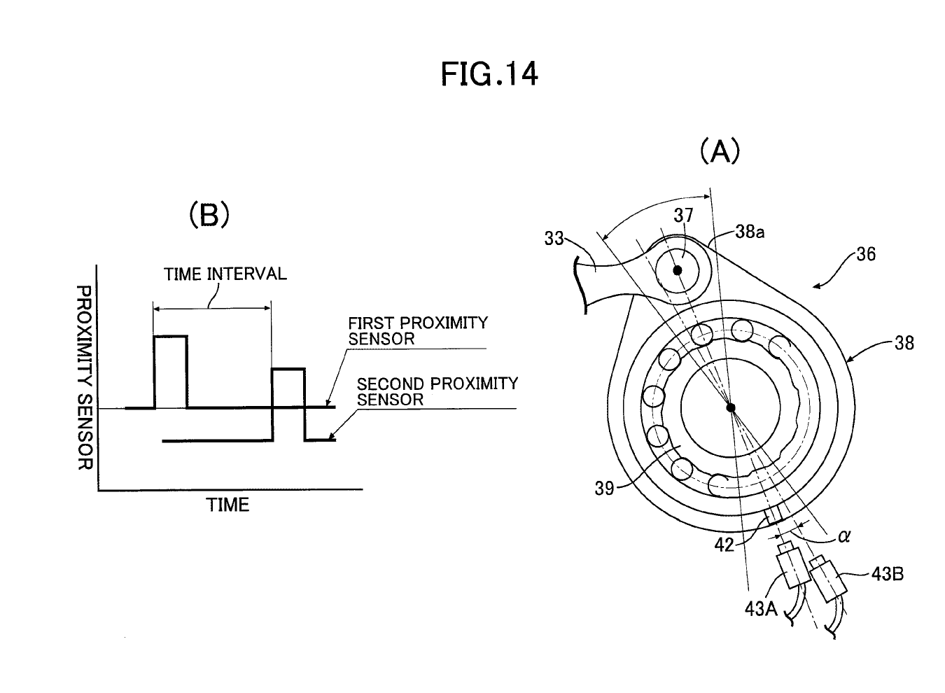

A second embodiment of the present invention is now explained by reference to FIG. 14.

The first embodiment employs the first projection 42A, the second projection 42B, and the proximity sensor 43, but as shown in FIG. 14, the second embodiment employs a projection 42, a first proximity sensor 43A, and a second proximity sensor 43B. One projection 42 is fixed to an outer peripheral face of an outer member 38 of any one one-way clutch 36, and the first proximity sensor 43A and the second proximity sensor 43B oppose the projection 42 with phases that are different from each other. In this arrangement, the first proximity sensor 43A is disposed at a position close to the projection 42 in the radial direction, and the second proximity sensor 43B is disposed at a position far from the projection 42 in the radial direction.

In accordance with the present embodiment also, an amount of eccentricity ε of an eccentric disk 19 can be estimated based on a time gap Tgap when the first proximity sensor 43A and the second proximity sensor 43B detect the projection 42 in the course of the outer member 38 of the one-way clutch 36 swinging. Moreover, a first output signal of the first proximity sensor 43A, which is close to the projection 42, is large and a second output signal of the second proximity sensor 43B, which is far from the projection 42, is small thereby enabling the first and second output signals to be reliably identified. Hence, when the time gap Tgap can not be detected in reality due to the swing angle of the outer member 38 being small, even if, in the course of the outer member 38 swinging in one direction, for example the first proximity sensor 43A detects the projection 42 and, in the course of swinging in the other direction, the first proximity sensor 43A again detects the projection 42, because the two detection signals are identical in magnitude, it is possible to avoid a situation in which the time gap Tgap, which can not be detected in reality, is erroneously detected.

Even if the first proximity sensor 43A and the second proximity sensor 43B are disposed at the same distance in the radial direction with respect to the projection 42, there will be no problem if means is provided that can discriminate an output signal of the first proximity sensor 43A from an output signal of the second proximity sensor 43B.

As hereinbefore described, in accordance with the present embodiment also, the same operational effects as those of the first embodiment can be achieved.

### Third Embodiment

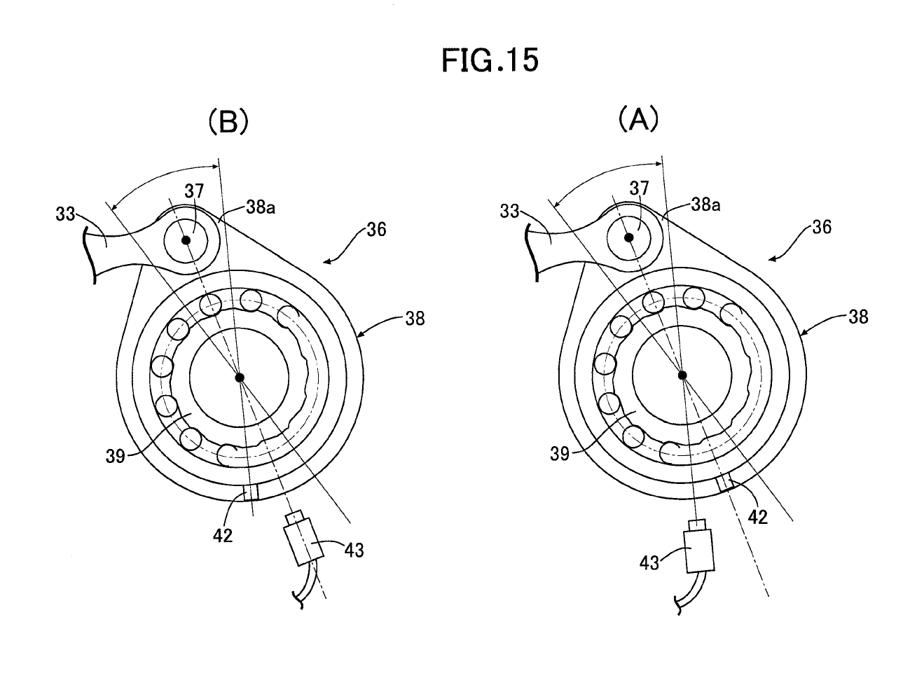

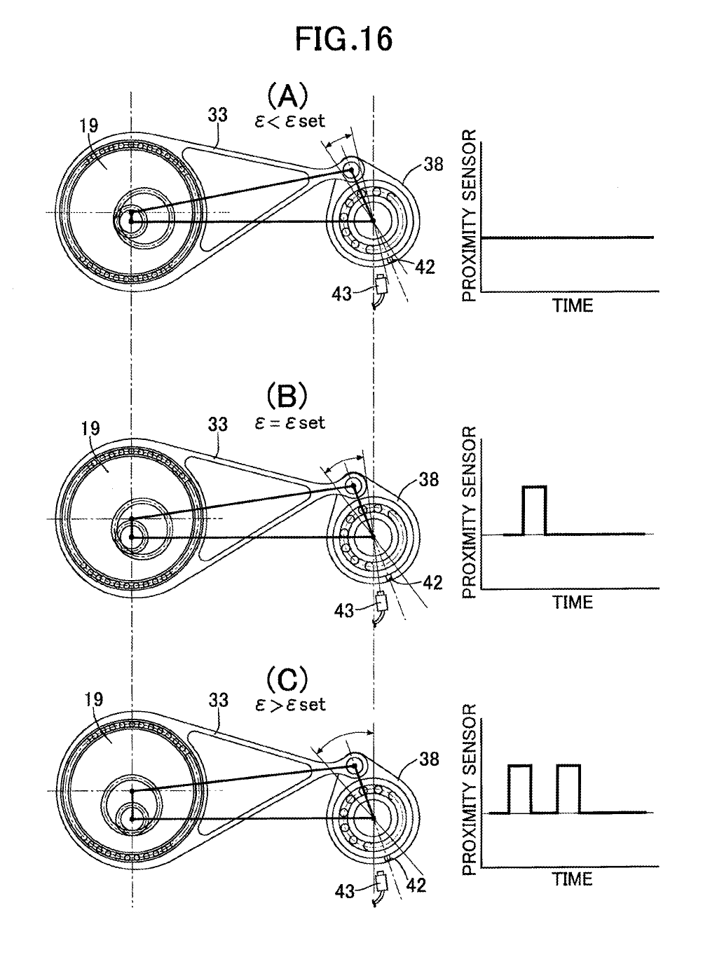

A third embodiment of the present invention is now explained by reference to FIG. 15 and FIG. 16.

The third embodiment has a simple structure that includes one projection 42 and one proximity sensor 43; as shown in FIG. 15(A) the position of the projection 42 is on the side opposite to a link pin 37 with an output shaft 13 interposed therebetween. The position of the proximity sensor 43 is biased only by a predetermined angle toward a position of the projection 42 when an outer member 38 of a one-way clutch 36 is at a middle position of the swing range.

This prevents the projection 42 from being detected by the proximity sensor 43 when, as shown in FIG. 16(A), an amount of eccentricity ε is smaller than a threshold value ε set, and an output signal therefore becomes flat. Furthermore, as shown in FIG. 16(B), when the amount of eccentricity ε coincides with the threshold value ε set, since the projection 42 is detected by the proximity sensor 43 only once while the outer member 38 swings back-and-forth once, one signal is detected. Furthermore, as shown in FIG. 16 (C), when the amount of eccentricity ε is larger than the threshold value ε set, while the outer member 38 swings back-and-forth once, since it is detected by the proximity sensor 43 once each time it swings back-and-forth, two signals are detected with a predetermined gap therebetween.

Therefore, when two detection signals are outputted while the outer member 38 swings back-and-forth once, a time gap Tgap between these two detection signals may be calculated, as in the first embodiment a swing angular velocity α′ of the outer member 38 can be calculated, and an amount of eccentricity ε of an eccentric disk 19 can be estimated from the swing angular velocity α′ with good accuracy.

As shown in FIG. 15(B), the same operational effects can be achieved even when the positions of the projection 42 and the proximity sensor 43 are exchanged for the embodiment of FIG. 15(A).

Embodiments of the present invention are explained above, but the present invention may be modified in a variety of ways as long as the modifications do not depart from the spirit and scope thereof.

For example, in the embodiments the amount of eccentricity ε estimated from the swing angular velocity α′ of the outer member 38 of the one-way clutch 36 is used for calibration of the amount of eccentricity tact estimated from the cumulative value of rotational angle of the electric motor 24 of the shift actuator 23, but the amount of eccentricity ε estimated from the swing angular velocity α′ may be used directly for control of the shift actuator 23.

Furthermore, the drive source of the present invention is not limited to the engine E of the embodiment and may be another drive source such as an electric motor.

1-5. (canceled)

6. A vehicle power transmission apparatus comprising:
an input shaft connected to a drive source;
an output shaft disposed in parallel to the input shaft;
an input side fulcrum that has a variable amount of eccentricity from an axis of the input shaft and rotates together with the input shaft;
a one-way clutch connected to the output shaft;
an output side fulcrum provided on an outer member of the one-way clutch; and
a connecting rod that connects the input side fulcrum and the output side fulcrum, wherein a projection fixed to the outer member is detected by a proximity sensor, and the amount of eccentricity is estimated based on a swing angular velocity of the outer member that is calculated from a time gap of a detection signal outputted by the proximity sensor, and
the apparatus comprises two proximity sensors that are disposed so as to be spaced in a peripheral direction of the outer member and one projection.

7. The vehicle power transmission apparatus according to claim 6, comprising:
a gear shaft disposed coaxially with the input shaft and changes the amount of eccentricity;
a shift actuator that rotates the gear shaft relative to the input shaft; and
an electric motor that drives the shift actuator,
a first estimated value for the amount of eccentricity estimated based on a cumulative value of rotational angle of the electric motor being calibrated with a second estimated value for the amount of eccentricity estimated based on the swing angular velocity of the outer member.

8. The vehicle power transmission apparatus according to claim 7, wherein when a deviation of the first estimated value with respect to the second estimated value is a predetermined value or greater, the first estimated value is calibrated with the second estimated value.
